(19) United States
(12) Patent Application Publication
(10) Pub. No.: US 2025/0384511 A1
(43) Pub. Date: Dec. 18, 2025

(54) DYNAMIC MUTUAL FEEDBACK-BASED METHOD FOR PROPERTY PLACEMENT IN FLOOD EVACUATION, PRODUCT, MEDIUM, AND DEVICE

(71) Applicant: CHINA THREE GORGES UNIVERSITY, Yichang City (CN)

(72) Inventors: Changwen LI, Yichang City (CN); Sujing LIN, Yichang City (CN); Jiale HUANG, Yichang City (CN); Haoxiong ZHAN, Yichang City (CN); Liting YANG, Yichang City (CN); Rui ZHOU, Yichang City (CN); Jiaqi ZHU, Yichang City (CN); Feihan LI, Yichang City (CN); Jiarui LI, Yichang City (CN); Zhiwei LI, Yichang City (CN); Xiaoxia ZENG, Yichang City (CN); Yahui QIN, Yichang City (CN); Xiaolei LV, Yichang City (CN); Shuyun DU, Yichang City (CN)

(21) Appl. No.: 18/949,229

(22) Filed: Nov. 15, 2024

(30) Foreign Application Priority Data
Jun. 14, 2024 (CN) 202410772815.5

(51) Int. Cl. G06Q 50/26; G06F 30/28; G06Q 10/0635

(52) U.S. Cl. CPC G06Q 50/265; G06F 30/28; G06Q 10/0635

(57) ABSTRACT

Provided are a dynamic mutual feedback-based method for property placement in flood evacuation, a product, a medium, and a device. The method includes: performing calculations using GIS and a two-dimensional hydrodynamic model, to generate a flood inundation map, and delineating village property risk zones and safety zones; constructing a road network topology, and performing road segment accessibility analysis based on the flood inundation map, to form an accessible road network topology; determining a property placement mode for a property risk zone of a current village; if the property placement mode is in-zone, placing properties in the property risk zone of the current village into a placement site of the current village; if the property placement mode is transfer, based on rules of grid-based transfer, classified transport, and dedicated-area placement, generating a feasible transfer placement route set; iteratively calculating paths to determine an optimal flood evacuation route.

### CROSS REFERENCE TO RELATED APPLICATION

This patent application claims the benefit and priority of Chinese Patent Application No. 202410772815.5, filed with the China National Intellectual Property Administration on Jun. 14, 2024, the disclosure of which is incorporated by reference herein in its entirety as part of the present application.

### TECHNICAL FIELD

The present disclosure relates to the technical field of emergency evacuation, and in particular, to a dynamic mutual feedback-based method for property placement in flood evacuation, a product, a medium, and a device.

### BACKGROUND

With the intensification of global climate change and human activities, extreme rainfall events have significantly increased in frequency, intensity, duration, and scope. This directly results in a heightened probability of severe flood disasters, which in turn causes tremendous economic losses. Against this backdrop, emergency evacuation has become a crucial non-engineering measure in dealing with flood disasters. Therefore, it is essential to explore an emergency evacuation and resettlement strategy that can ensure the organized, orderly, safe, and timely transfer of important properties during extreme flood events. This is vital for minimizing the economic losses caused by floods.

Traditional methods for property placement in flood evacuation usually rely on preset flood inundation scenarios to formulate emergency evacuation plans. Residents and rescue vehicles transfer important properties to designated placement sites following established routes. However, these methods are largely based on hypothetical flood scenarios and overly rely on historical experiences. Traditional property placement methods lack consideration for the dynamic mutual feedback relationships among “water” (the impact of flood risk), “objects” (property placement status), and “land” (risk areas, evacuation areas, and transfer routes). The absence of the mutual feedback relationships manifests in several ways: on one hand, it fails to adjust transfer routes based on real-time flood risk information, making established routes potentially unsafe or unfeasible, thus lacking connectivity with flood risk; on the other hand, properties in different risk areas and of various types are not categorized for transport, leading to inefficiencies in transfer routing; furthermore, multiple properties are placed in the same area, resulting in underutilization of evacuation areas and low resettlement efficiency. To achieve the dynamic mutual feedback, it is essential to establish a flood evacuation method based on orderly rules to ensure the safety and efficiency of property transfers.

### SUMMARY

An objective of the present disclosure is to provide a dynamic mutual feedback-based method for property placement in flood evacuation, a product, a medium, and a device, to improve the efficiency and safety of property placement.

To achieve the above objective, the present disclosure provides the following technical solutions.

According to a first aspect, the present disclosure provides a dynamic mutual feedback-based method for property placement in flood evacuation, including:
collecting basic geographic data, hydrometeorological data, and fundamental water facility data of a target area as basic data, where the basic geographic data includes base terrain, road network, administrative division, digital elevation model, and remote sensing image data; the hydrometeorological data includes measured rainfall, streamflow, flow speed, and water level data from hydrological and meteorological stations within a watershed; and the fundamental water facility data includes scales of flood control engineering facilities, engineering design parameters, and operational status data;
performing calculations based on the basic data of the target area by using a Geographic Information System (GIS) combined with a two-dimensional hydrodynamic model, to generate a flood inundation map of the target area;
delineating village property risk zones and village property safety zones based on the flood inundation map of the target area;
constructing a road network topology based on the road network data of the target area, and performing road segment accessibility analysis based on the flood inundation map to form an accessible road network topology;
determining a property placement mode for a property risk zone of a current village based on the flood inundation map, where the property placement mode includes in-zone placement and transfer placement;
if the property placement mode is in-zone placement, evacuating properties from the property risk zone of the current village to a placement site within the current village;
if the property placement mode is transfer placement, by using the property risk zone of the current village as a starting point and a placement site in a property safety zone of another village as an endpoint, generating a feasible transfer placement route set based on rules of grid-based transfer, classified transport, and dedicated-area placement according to the accessible road network topology;
iteratively calculating paths for the feasible transfer placement route set based on a heuristic optimization algorithm, to determine an optimal flood evacuation route; and
based on the optimal flood evacuation route, transferring the properties in the property risk zone of the current village to the placement site in the property safety zone of another village.

Optionally, said performing calculations based on the basic data of the target area by using the GIS combined with the two-dimensional hydrodynamic model, to generate the flood inundation map of the target area specifically includes:
dividing the target area into grid cells using two-dimensional hydrodynamic modeling software;
setting boundary conditions, initial conditions, and input parameters for the two-dimensional hydrodynamic model based on the basic data of the target area, and performing calculations using the two-dimensional hydrodynamic modeling software to obtain risk factor values for each grid cell, where risk factors for each grid cell include: flood peak arrival time, inundation depth, and inundation duration; and
converting the risk factor values of each grid cell into visual graphics using the GIS, to obtain the flood inundation map of the target area.

Optionally, said delineating the village property risk zones and the village property safety zones based on the flood inundation map of the target area specifically includes:
defining the village property risk zones according to the following formula:

$$M = {\sum }_{m = 1}^{x} {S}_{m , j} ( Z > {Z}_{0} ) , {S}_{m , j} ∈ {S}_{j} ,$$

where M represents a range of a village property risk zone; Sⱼ represents an administrative region of village j; S_{m,j} represents an m-th grid area of village j; Z represents an inundation depth of a grid cell; Z₀ represents an actual elevation of a grid cell; S_{m,j}(Z>Z₀) represents a risk grid area; and x represents the number of risk grid cells; and
defining the village property safety zones according to the following formula:

$$D = {\sum }_{d = 1}^{y} {S}_{d , j} ( Z \leq {Z}_{0} ) , {S}_{d , j} ∈ {S}_{j} ,$$

where D represents a range of a village property safety zone; S_{d,j} represents a d-th grid area of village j; S_{d,j}(Z≤Z₀) represents a safety grid zone; S area; and y represents the number of safety grid cells.

Optionally, said constructing the road network topology based on the road network data of the target area, and performing road segment accessibility analysis based on the flood inundation map to form the accessible road network topology specifically includes:
with road data from the road network data as edges, creating nodes at road intersections and endpoints, and assigning attributes to the edges and the nodes within a road network, to form an initial road network topology;
determining flooded road segments in the initial road network topology and corresponding inundation depths based on the flood inundation map;
treating road segments with the inundation depths exceeding a preset distance from road surface as impassable road segments; and
severing the impassable road segments in the initial road network topology by using a node tool in the GIS, to form the accessible road network topology.

Optionally, said determining the property placement mode for the property risk zone of the current village based on the flood inundation map specifically includes:
when identification conditions

$$\{ \begin{matrix}{Z}_{{i}_{p}} > {Z}_{i} + {Z}_{i}^{′} \\ {\sum }_{i = 1}^{{x}_{1}} {C}_{i , {H}_{f}} \leq {\sum }_{{i}_{p} = 1}^{{z}_{1}} {C}_{{i}_{p} , {H}_{f}}^{max} \\ {i}_{p} ∈ \{ {i}_{1} , {i}_{2} , {i}_{3} \} \\ {H}_{f} ∈ \{ {H}_{1} , {H}_{2} , {H}_{3} \}\end{matrix}$$

for the placement site in the property risk zone of the current village are satisfied, determining that the property placement mode for the property risk zone of the current village is in-zone placement, where C_{i,H}_{_{f}} represents the number of type-H_{f} properties in property risk zone i of the current village; X₁ represents the number of property risk zones in the current village; iₚ represents a placement site in property risk zone i of the current village, referred to as a placement site in the current village; i₁ represents buildings in the current village; i₂ represents temporary storage facilities in the current village; i₃ represents a high-elevation area in the current village; [symbol] represents the number of placement sites in the current village; H_{f} represents a property type; H₁ represents electrical and mechanical equipment; H₂ represents grains and oils; H₃ represents important archival documents;

$${C}_{{i}_{p} , {H}_{f}}^{max}$$

represents a maximum capacity for type-H_{f} properties in placement site iₚ of the current village; Zᵢ_{ₚ} represents a height of placement site iₚ in the current village; Zᵢ represents an inundation depth of property risk zone i in the current village; and Z′ᵢ represents a safety margin of property risk zone i in the current village; and
when identification conditions

$$\{ \begin{matrix}{Z}_{{i}_{p}} \leq {Z}_{i} + {Z}_{i}^{′} \\ {\sum }_{i = 1}^{{x}_{1}} {C}_{i , {H}_{f}} \leq {\sum }_{{q}_{p} = 1}^{{z}_{2}} {C}_{{q}_{p} , {H}_{f}}^{max} \\ {q}_{p} ∈ \{ {q}_{1} , {q}_{2} , {q}_{3} , {q}_{4} \}\end{matrix}$$

for a placement site in a property safety zone of another village are satisfied, determining that the property placement mode for the property risk zone of the current village is transfer placement, where qₚ represents a placement site in a property safety zone of another village, referred to as a placement site in another village; q₁ represents empty factories; q₂ represents warehouses; q₃ represents school classrooms; q₄ represents school playgrounds; [symbol] represents the number of placement sites in another village; and

$${C}_{{q}_{p} , {H}_{f}}^{max}$$

represents a maximum capacity for type-H_{f} properties in placement site qₚ of another village.

Optionally, said generating the feasible transfer placement route set based on the rules of grid-based transfer, classified transport, and dedicated-area placement according to the accessible road network topology specifically includes:
establishing a grid-based transfer rule in which transfer routes of property risk zones of different villages do not overlap:

$$\{ \begin{matrix}H ( i ) = H ( q ) + H ( {i}^{0} ) \\ ∀ i , {i}^{′} ∈ \{ 1 , 2 , … , {x}_{1} \} , i \neq {i}^{′} ⇒ ( {l}_{i} ⋂ {l}_{{i}^{′}} = ∅ )\end{matrix} ,$$

where lᵢ represents all feasible transfer routes related to property risk zone i of the current village in the accessible road network topology; lᵢ represents all feasible transfer routes related to property risk zone i′ in the accessible road network topology; H(i) represents a collection of properties awaiting transfer from property risk zone i of the current village; H(q) represents a collection of properties being transferred from property risk zone i of the current village to placement site qₚ in another village; and H(i⁰) represents a collection of properties placed in placement site iₚ the current village;
establishing a classified transport rule that prevents vehicle routes for transferring different types of from properties competing for space:

$$\{ \begin{matrix}∀ i , {i}^{′} ∈ \{ 1 , 2 , … , {x}_{1} \} , i \neq {i}^{′} ⇒ ( {L}_{i} ⋂ {L}_{{i}^{′}} = ∅ ) \\ for {h}_{f} ∈ \{ {h}_{1} , {h}_{2} , {h}_{3} , {h}_{4} \}\end{matrix} ,$$

where h_{f} represents vehicles for transporting different types of properties; h₁ represents trucks for transporting electrical and mechanical equipment; h₂ represents trucks for transporting grains and oils; h₃ represents pickup trucks for transporting important archival documents; h₄ represents trucks for transporting other important properties of residents; Lᵢ represents feasible transfer routes for all property transfer vehicles in property risk zone i of the current village in the accessible road network topology; and L_{i′} represents feasible transfer routes for all property transfer vehicles in property risk zone i′ of the current village in the accessible road network topology;
establishing a dedicated-area placement rule that stores different types of properties at corresponding placement sites:

$$\{ \begin{matrix}{H}_{f} ( {q}_{f} ) ∈ {H}_{f} ( i ) \\ {H}_{f} = \{ {H}_{1} , {H}_{2} , {H}_{3} , {H}_{4} \} \\ {q}_{f} ∈ {q}_{p}\end{matrix} ,$$

where q_{f} represents dedicated areas for storing different types of properties at placement site qₚ of another village; H₄ represents other important properties of residents; H_{f}(i) represents types of properties awaiting transfer from property risk zone i of the current village; and H_{f}(q_{f}) represents types of properties being transferred from property risk zone i of the current village to dedicated areas q_{f}; and
for property risk zone i of the current village of which the property placement mode is transfer placement, by using a GIS spatial analysis, generating the feasible transfer placement route set containing all feasible transfer placement routes based on the rules of grid-based transfer, classified transport, and dedicated-area placement, with property risk zone i of the current village as a starting point and placement site qₚ in another village as an endpoint.

Optionally, said iteratively calculating paths for the feasible transfer placement route set based on the heuristic optimization algorithm to determine the optimal flood evacuation route specifically includes:
constructing an objective function

$$f = min T = min {\sum }_{i = 1}^{{x}_{1}} {\sum }_{k = 1}^{{x}_{2}} a ( {l}_{i , k} ) \times t ( {l}_{i , k} )$$

for the optimal flood evacuation route as well as corresponding constraints, where the constraints include constraints on road segment travel time, constraints on road design speeds, and constraints on traffic flow and property transfer volumes, where T represents a total transfer time; l_{i,k} represents the k-th feasible transfer placement route for property risk zone i of the current village; a(l_{i,k}) and t(l_{i,k}) represent a traffic flow and time consumed for property transfer via feasible transfer placement route l_{i,k}, respectively; and X₂ represents the number of feasible transfer placement routes for property risk zone i of the current village; and
iteratively calculating paths for the feasible transfer placement route set based on the heuristic optimization algorithm, to determine an optimal flood evacuation route that satisfies the objective function and the corresponding constraints.

According to another aspect, the present disclosure further provides a computer program product, including a computer program. The computer program, when executed by a processor, implements the dynamic mutual feedback-based method for property placement in flood evacuation.

According to still another aspect, the present disclosure further provides a computer-readable storage medium storing a computer program, where the computer program, when executed by a processor, implements the dynamic mutual feedback-based method for property placement in flood evacuation.

According to yet another aspect, the present disclosure further provides a computer device, including a memory, a processor, and a computer program stored in the memory and executable on the processor, where the computer program is executed by the processor to implement the dynamic mutual feedback-based method for property placement in flood evacuation.

According to specific embodiments provided in the present disclosure, the present disclosure has the following technical effects:

On one hand, the present disclosure provides foundational support for the orderly development of subsequent property placement tasks by delineating village property risk zones and village property safety zones within the administrative area of a village based on the flood inundation map. On the other hand, the present disclosure utilizes a GIS spatial analysis to determine the placement modes for different types of properties in the village property risk zone and the corresponding placement sites based on flood risk conditions of the village property risk zone. This reflects the mutual feedback relationships between “water” and “objects,” as well as “water” and “land.” The rules of grid-based transfer, dedicated-area placement, and classified transport are established to generate a set of all feasible transfer placement routes, reflecting the mutual feedback relationship between “objects” and “land.” Through these methods, the present disclosure optimizes resource allocation, reduces resource waste, improves traffic efficiency, and enhances the accuracy of transportation, thereby ensuring the safety and efficiency of property transfers. Additionally, the present disclosure employs the heuristic optimization algorithm to iteratively solve for optimal paths, allowing adaptation to road network structures of varying scales and complexities. Through stage-by-stage optimization, the present disclosure achieves rapid property placement during flood emergencies and enhances the emergency response speed.

### BRIEF DESCRIPTION OF THE DRAWINGS

To describe the technical solutions in embodiments of the present disclosure or in the prior art more clearly, the accompanying drawings required for the embodiments are briefly described below. Apparently, the accompanying drawings in the following description show merely some embodiments of the present disclosure, and those of ordinary skill in the art may still derive other accompanying drawings from these accompanying drawings without creative efforts.

FIG. 1 is a flowchart of a dynamic mutual feedback-based method for property placement in flood evacuation according to the present disclosure;

FIG. 2 is a schematic diagram illustrating a principle of a dynamic mutual feedback-based method for property placement in flood evacuation according to the present disclosure;

FIG. 3 is a simplified diagram of dynamic mutual feedback-based routes for property placement in flood evacuation; and

FIG. 4 is a schematic diagram of a shortest-time path model for dynamic mutual feedback-based property placement in flood evacuation.

### DETAILED DESCRIPTION OF THE EMBODIMENTS

The technical solutions of the embodiments of the present disclosure are clearly and completely described below with reference to the drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

The present disclosure aims to provide a dynamic mutual feedback-based method for property placement in flood evacuation, a product, a medium, and a device, to improve the efficiency and safety of property placement.

To make the above objectives, features, and advantages of the present disclosure clearer and more comprehensible, the present disclosure will be further described in detail below with reference to the accompanying drawings and the specific embodiments.

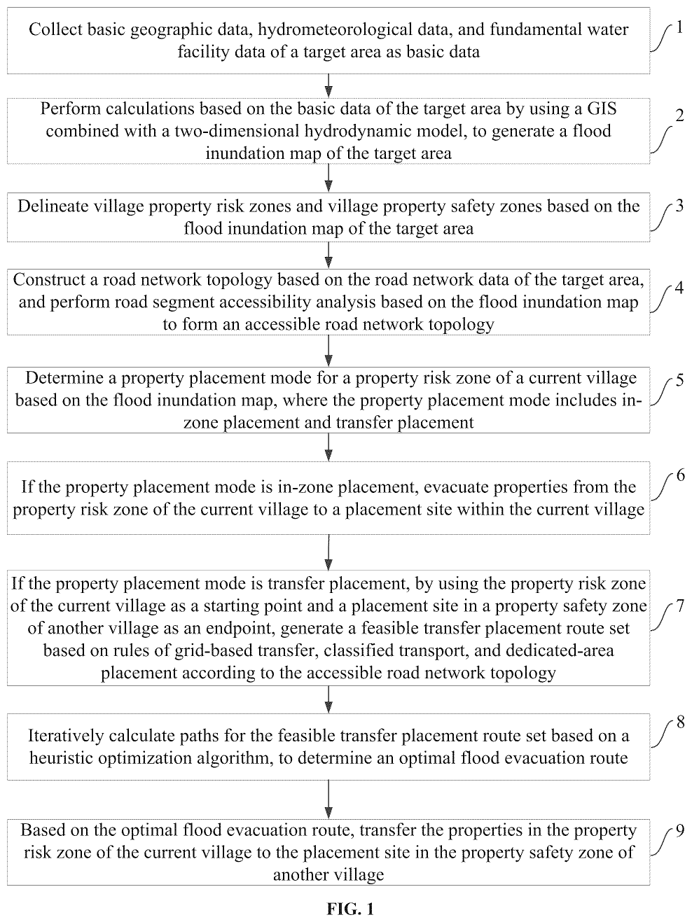

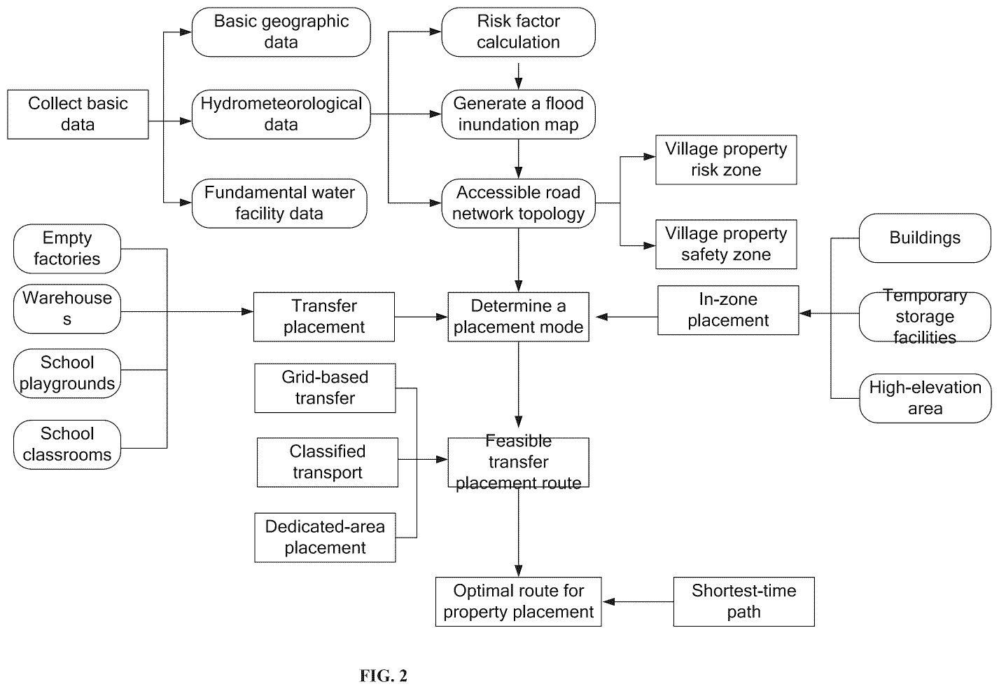

FIG. 1 is a flowchart of a dynamic mutual feedback-based method for property placement in flood evacuation according to the present disclosure, and FIG. 2 is a schematic diagram illustrating a principle of a dynamic mutual feedback-based method for property placement in flood evacuation according to the present disclosure. Referring to FIG. 1 and FIG. 2, the present disclosure provides a dynamic mutual feedback-based method for property placement in flood evacuation, including:

Step 1: Collect basic geographic data, hydrometeorological data, and fundamental water facility data of a target area as basic data.

The basic geographic data collected for the target area includes base terrain, road network, administrative division, digital elevation model, and remote sensing image data. The road network data specifically includes road names, locations, grades, lengths, traffic flow, travel times, and actual operational capacities. The hydrometeorological data includes measured rainfall, streamflow, flow speed, and water level data from hydrological and meteorological stations within a watershed. The fundamental water facility data includes scales of flood control engineering facilities, engineering design parameters, and operational status data.

Step 2: Perform calculations based on the basic data of the target area by using a GIS combined with a two-dimensional hydrodynamic model, to generate a flood inundation map of the target area.

In the present disclosure, flood risk factors are computed based on the collected basic data and the two-dimensional hydrodynamic model, the boundaries of village property risk zones and village property safety zones are identified, and an accessible road network topology is constructed.

Specifically, the step 2 includes:
Step 2.1: Divide the target area into grid cells using two-dimensional hydrodynamic modeling software.

Two-dimensional hydrodynamic modeling software such as MIKE 21, SOBEK, or HEC-RAS is selected to divide the target area into grid cells.

Step 2.2: Set boundary conditions, initial conditions, and input parameters for the two-dimensional hydrodynamic model based on the basic data of the target area, and perform calculations using the two-dimensional hydrodynamic modeling software to obtain risk factor values for each grid cell, where risk factors for each grid cell include: flood peak arrival time, inundation depth, and inundation duration.

The boundary conditions and initial conditions of the model are set based on the collected basic data (such water level, streamflow, and flow speed), and parameters (such as a bed friction coefficient) of the model are input. Based on known conditions, calculations are performed using the two-dimensional hydrodynamic modeling software to obtain the risk factor values for each grid cell, including flood peak arrival time, inundation depth (relative to mean sea level), and inundation duration.

Step 2.3: Convert the risk factor values of each grid cell into visual graphics using the GIS, to obtain the flood inundation map of the target area.

By combining the GIS with the calculation results of the two-dimensional hydrodynamic model, the risk factor values of each grid cell, such as the flood peak arrival time, inundation depth, and inundation duration, are converted into visual graphics, for example, using different colors or shades to represent varying inundation depths, thereby generating the flood inundation map of the target area.

Step 3: Delineate village property risk zones and village property safety zones based on the flood inundation map of the target area.

The flood inundation map obtained from the hydrodynamic modeling software is imported into the GIS and converted into vector data using a raster-to-vector tool. An actual elevation of each grid cell (relative to mean sea level) Z₀ is compared with the calculated inundation depth Z. Grid cells with inundation depths exceeding actual elevations are classified as risk grid cells S(Z>Z₀).

Based on the comparison results, using the administrative boundaries of a village as a framework, an area composed of risk grid cells is identified as a village property risk zone, with a determination formula as follows:

$$M = {\sum }_{m = 1}^{x} {S}_{m , j} ( Z > {Z}_{0} ) , {S}_{m , j} ∈ {S}_{j} \qquad ( 1 )$$

where M represents a range of a village property risk zone; Sⱼ represents an administrative region of village j; S_{m,j} represents an m-th grid area of village j; Z represents an inundation depth of a grid cell; Z₀ represents an actual elevation of a grid cell; S_{m,j}(Z>Z₀) represents a risk grid area; and x represents the number of risk grid cells.

Similarly, using the administrative boundaries of a village as a framework, an area composed of safety grid cells are identified as a village property safety zone, with a determination formula as follows:

$$D = {\sum }_{d = 1}^{y} {S}_{d , j} ( Z \leq {Z}_{0} ) , {S}_{d , j} ∈ {S}_{j} \qquad ( 2 )$$

where D represents a range of a village property safety zone; S_{d,j} represents a d-th grid area of village j; S_{d,j}(Z≤Z₀) represents a safety grid area; and y represents the number of safety grid cells.

By using the two-dimensional hydrodynamic modeling software, the village property risk zones and village property safety zones are generated based on the identification results, and are updated and maintained in real time.

Step 4: Construct a road network topology based on the road network data of the target area, and perform road segment accessibility analysis based on the flood inundation map to form an accessible road network topology.

The road network topology is constructed based on the collected road network data (such as road grades and locations). Step 4 specifically includes:

Step 4.1: With road data from the road network data as edges, create nodes at road intersections and endpoints, and assign attributes to the edges and the nodes within a road network, to form an initial road network topology.

In the GIS, a new topological layer or workspace is created and road vector data from the road network data is added to the topology, where the road data is used as edges. Topological rules are defined, where edges should terminate at nodes and cannot self-intersect. Road intersections and endpoints are identified using the GIS, and nodes are created at these locations. Then, attribute information is assigned to the edges and nodes within the road network, such as segment names and grades. The attribute data is stored in an attribute table, and matches with the corresponding vector graphics in a one-to-one manner, thus forming the initial road network topology.

Step 4.2: Determine flooded road segments in the initial road network topology and corresponding inundation depths based on the flood inundation map.

Specifically, based on the initial road network topology, a layer overlay analysis is performed on the established topological road network, the flood inundation map, the village property risk zones, and the village property safety zones by using the GIS. A flood inundation layer is analyzed to identify which road segments are submerged and corresponding inundation depths.

Step 4.3: Treat road segments with the inundation depths exceeding a preset distance from road surface as impassable road segments.

Based on the flooding depth and road characteristics (such as road surface height), road segments with the inundation depths exceeding the preset distance (30 m to 50 m) from the road surface are treated as impassable road segments.

Step 4.4: Sever the impassable road segments in the initial road network topology by using a node tool in the GIS, to form the accessible road network topology.

Based on the foregoing flooding situation analysis, the node tool in the GIS is used to update the road network by severing impassable roads, thus forming the accessible road network topology.

Step 5: Determine a property placement mode for a property risk zone of a current village based on the flood inundation map, where the property placement mode includes in-zone placement and transfer placement.

By using a GIS spatial analysis, spatial overlay is performed on building spatial data and property data in the target area with the flood inundation map; inundation depths for different types of buildings and a safety margin (such as a flood fluctuation value) for the village property risk zone in response to the flood are calculated, thereby determining the property placement mode for the village property risk zone.

### 5.1 In-Zone Placement

When a sum of the inundation depth and the safety margin does not exceed a topographic height of an in-zone placement site corresponding to the current village, in-zone placement can be adopted for electrical and mechanical equipment, grains and oils, as well as important archival documents. Identification conditions for the placement site in the property risk zone of the current village are as follows:

$$\{ \begin{matrix}{Z}_{{i}_{p}} > {Z}_{i} + {Z}_{i}^{′} \\ {\sum }_{i = 1}^{{x}_{1}} {C}_{i , {H}_{f}} \leq {\sum }_{{i}_{p} = 1}^{{z}_{1}} {C}_{{i}_{p} , {H}_{f}}^{max} \\ {i}_{p} ∈ \{ {i}_{1} , {i}_{2} , {i}_{3} \} \\ {H}_{f} ∈ \{ {H}_{1} , {H}_{2} , {H}_{3} \}\end{matrix} \qquad ( 3 )$$

When the conditions of formula (3) are met, it is determined that the property placement mode for the property risk zone of the current village is in-zone placement. In the present disclosure, the i-th property risk zone of the current village is referred to as property risk zone i of the current village; C_{i,H}_{_{f}} represents the number of type-H_{f} properties in property risk zone i of the current village; X₁ represents the number of property risk zones in the current village; iₚ represents a placement site in property risk zone i of the current village, referred to as a placement site in the current village; i₁ represents buildings in the current village; i₂ represents temporary storage facilities in the current village; i₃ represents a high-elevation area in the current village; [symbol] represents the number of placement sites in the current village; H_{f} represents a property type; H₁ represents electrical and mechanical equipment; H₂ represents grains and oils; H₃ represents important archival documents; H₄ represents other important properties of residents, including agricultural machinery, two-wheeled and three-wheeled motor vehicles, and the like.

$${C}_{{i}_{p} , {H}_{f}}^{max}$$

represents a maximum capacity for type-H_{f} properties in placement site iₚ of the current village; Zᵢ_{ₚ} represents a height of placement site iₚ in the current village; Zᵢ represents an inundation depth of property risk zone i in the current village; and Z′ᵢ represents a safety margin of property risk zone i in the current village.

### 5.2 Transfer Placement

When the sum of the inundation depth and the safety margin exceeds the topographic height of the in-zone placement site corresponding to the current village, transfer placement should be adopted for the electrical and mechanical equipment, grains and oils, and important archival documents. Identification conditions for a placement site in a property safety zone of another village are follows:

$$\{ \begin{matrix}{Z}_{{i}_{p}} \leq {Z}_{i} + {Z}_{i}^{′} \\ {\sum }_{i = 1}^{{x}_{1}} {C}_{i , {H}_{f}} \leq {\sum }_{{q}_{p} = 1}^{{z}_{2}} {C}_{{q}_{p} , {H}_{f}}^{max} \\ {q}_{p} ∈ \{ {q}_{1} , {q}_{2} , {q}_{3} , {q}_{4} \}\end{matrix} \qquad ( 4 )$$

When the conditions of formula (4) are met, it is determined that the property placement mode for the property risk zone of the current village is transfer placement. where qₚ represents a placement site in a property safety zone of another village, referred to as a placement site in another village; q₁ represents empty factories; q₂ represents warehouses; q₃ represents school classrooms; q₄ represents school playgrounds; [symbol] represents the number of placement sites in another village; and

$${C}_{{q}_{p} , {H}_{f}}^{max}$$

represents a maximum capacity for type-H_{f} properties in placement site qₚ of another village.

Furthermore, for areas where other important properties of residents are located, regardless of whether the sum of the inundation depth and safety margin exceeds the topographic height of the corresponding placement site of the current village, transfer placement should be adopted.

Step 6: If the property placement mode is in-zone placement, evacuate properties from the property risk zone of the current village to a placement site within the current village.

When the conditions of formula (3) are met, indicating that properties can be placed within the current village, in this case, the properties from the property risk zone of the current village is evacuated to a placement site within the current village.

Step 7: If the property placement mode is transfer placement, by using the property risk zone of the current village as a starting point and a placement site in a property safety zone of another village as an endpoint, generate a feasible transfer placement route set based on rules of grid-based transfer, classified transport, and dedicated-area placement according to the accessible road network topology.

When the conditions of formula (4) are met, properties in the property risk zone of the current village need to be transferred to another village, where rules for transfer placement include grid-based transfer, classified transport, and dedicated-area placement described below.

### 7.1 Grid-Based Transfer

Based on matching between villages and matching between village teams, a property transfer occurs at a village level, with properties moving from one village to another. During the transfer process, it is required that transfer routes for different village property risk zones do not overlap. The corresponding grid-based transfer rule is as follows:

$$\{ \begin{matrix}H ( i ) = H ( q ) + H ( {i}^{0} ) & \\ ∀ i , {i}^{′} ∈ \{ 1 , 2 , … , {x}_{1} \} , & i \neq {i}^{′} ⇒ ( {l}_{i} ⋂ {l}_{{i}^{′}} = ∅ )\end{matrix} \qquad ( 5 )$$

where lᵢ represents all feasible transfer routes related to property risk zone i of the current village in the accessible road network topology; l_{i′} represents all feasible transfer routes related to property risk zone i′ in the accessible road network topology; H(i) represents a collection of properties awaiting transfer from property risk zone i of the current village; H(q) represents a collection of properties being transferred from property risk zone i of the current village to placement site qₚ in another village; and H(i⁰) represents a collection of properties placed in placement site iₚ in the current village.

### 7.2 Classified Transport

Different types of properties are transported by designated vehicles. During transportation, it is required that the vehicle transfer routes for various types of properties within different village property risk zones do not overlap. The corresponding classified transport rule is as follows:

$$\{ \begin{matrix}∀ i , {i}^{′} ∈ \{ 1 , 2 , … , {x}_{1} \} , & i \neq {i}^{′} ⇒ ( {L}_{i} ⋂ {L}_{{i}^{′}} = ∅ ) \\ for {h}_{f} ∈ \{ {h}_{1} , {h}_{2} , {h}_{3} , {h}_{4} \} & \end{matrix} \qquad ( 6 )$$

where h_{f} represents vehicles for transporting different types of properties; h₁ represents trucks for transporting electrical and mechanical equipment; h₂ represents trucks for transporting grains and oils; h₃ represents pickup trucks for transporting important archival documents; and h₄ represents trucks for transporting other important properties of residents. Lᵢ represents feasible transfer routes for all property transfer vehicles in property risk zone i of the current village in the accessible road network topology; and L_{i′} represents feasible transfer routes for all property transfer vehicles in property risk zone i′ of the current village in the accessible road network topology.

### 7.3 Dedicated-Area Placement

Different types of properties are stored in their respective placement areas. The dedicated-area placement established on this basis is as follows:

$$\{ \begin{matrix}{H}_{f} ( {q}_{f} ) ∈ {H}_{f} ( i ) \\ {H}_{f} = \{ {H}_{1} , {H}_{2} , {H}_{3} , {H}_{4} \} \\ {q}_{f} ∈ {q}_{p}\end{matrix} \qquad ( 7 )$$

where q_{f} represents dedicated areas for storing different types of properties at placement site qₚ of another village; H₄ represents other important properties of residents; H_{f}(i) represents types of properties awaiting transfer from property risk zone i of the current village; and H_{f}(q_{f}) represents types of properties being transferred from property risk zone i of the current village to dedicated areas q_{f}.

The present disclosure does not perform path optimization calculations for village property risk zones that adopt the in-zone placement mode. However, for property risk zone i of the current village of which the property placement mode is transfer placement, by using a GIS spatial analysis, the feasible transfer placement route set containing all feasible transfer placement routes needs to be generated based on the rules of grid-based transfer, classified transport, and dedicated-area placement, with property risk zone i of the current village as a starting point and placement site qₚ in another village as an endpoint.

Step 8: Iteratively calculate paths for the feasible transfer placement route set based on a heuristic optimization algorithm, to determine an optimal flood evacuation route.

Based on the feasible transfer placement route set, a heuristic optimization algorithm is run using a network analysis tool in the GIS. With a village property risk zone as a starting point and a placement site in a property safety zone of another village as an endpoint, iterative path calculations are performed, resulting in optimal flood evacuation routes from each village property risk zone to a placement site in a specified village property safety zone. Step 8 specifically includes:

Step 8.1: Construct an objective function for the optimal flood evacuation route:

$$f = min T = min {\sum }_{i = 1}^{{x}_{1}} {\sum }_{k = 1}^{{x}_{2}} a ( {l}_{i , k} ) \times t ( {l}_{i , k} ) \qquad ( 8 )$$

where T represents a total transfer time (in minutes); l_{i,k} represents the k-th feasible transfer placement route for property risk zone i of the current village, referred to as transfer route for short; a(l_{i,k}) and t(l_{i,k}) represent a traffic flow and time (in minutes) consumed for property transfer via feasible transfer placement route l_{i,k}, respectively; and X₂ represents the number of feasible transfer placement routes for property risk zone of i the current village.

Constraints corresponding to the objective function (8) include constraints on travel time of road segments, constraints on road design speeds, and constraints on traffic flow and property transfer volumes.

Step 8.2: Establish constraints on road segment travel time as follows:

$$t ( {l}_{i , k} ) = {{\sum }^{{x}_{3}}}_{c = 1} {t}_{c} ( {l}_{i , k} ) \qquad ( 9 )$$

where t_{c}(l_{i,k}) represents time (in minutes) taken for vehicles to pass through road segment c; X₃ represents the number of road segments in the k-th transfer route l_{i,k} for property risk zone i of the current village; and t(l_{i,k}) represents a travel time (in minutes) for the k-th transfer route l_{i,k} for property risk zone i of the current village.

The property evacuation transfer will be influenced by factors such as road grade and road congestion. The present disclosure establishes a road authority function and corresponding constraints, using t_{c}(l_{i,k}) as a time index to represent a comprehensive time attribute of each road segment:

$${t}_{c \text{}} ( {l}_{i , k} ) = [ \text{} 2 + \sqrt{{β}^{2} ( 1 - {x}_{c} / {C}_{c} ) + {α}^{2}} - β ( 1 - {x}_{c} / {C}_{c} ) - α ] {t}_{c 0} ( {l}_{i , k} ) + {R}_{c} ( {l}_{i , k} ) / {v}^{′} \qquad ( 10 )$$

where t_{c}(l_{i,k}) represents a time index for road segment c; X_{c} represents traffic flow on the road segment (vehicles/hour); C_{c} represents an actual capacity (vehicles/hour); t_{c0}(l_{i,k}) represents a travel time (in minutes) on road segment c when there is no other traffic; R_{c}(l_{i,k}) represents a length of road segment c; v′ represents a vehicle speed; α and β range from 1.4 to 1.8.

The vehicle speed v′ used in formula (10) is a modified travel speed. To ensure the safety of the evacuation process, a crowd interference factor, θ₁, a road curvature influence factor θ₂, and a road width influence factor θ₃ are introduced. Specific values of these factors need to be determined based on the “Urban Road Traffic Planning and Design Specifications,” “Highway Engineering Technical Standards,” and field observations. The modified travel speed is as follows:

$${v}^{′} = {θ}_{1} {θ}_{2} {θ}_{3} {v}_{0} \qquad ( 11 )$$

where v₀ represents a set of design travel speeds for various vehicles on different roads; and v′ represents a set of modified design travel speeds.

Step 8.3: Establish constraints on road design speeds.

Considering the speed limits on roads, and in conjunction with the “Urban Road Traffic Planning and Design Specifications,” “Urban Road Design Specifications,” and “Highway Engineering Technical Standards,” the constraints on design speeds for various road grades (in km/h) are as follows:

$$\{ \begin{matrix}{v}_{1} ( {g}_{0} , {h}_{f} ) \leq {v}_{0} ( {g}_{0} , {h}_{f} ) \leq {v}_{2} ( {g}_{0} , {h}_{f} ) \\ {v}_{1} ( {g}_{1} , {h}_{f} ) \leq {v}_{0} ( {g}_{1} , {h}_{f} ) \leq {v}_{2} ( {g}_{1} , {h}_{f} ) \\ {v}_{1} ( {g}_{2} , {h}_{f} ) \leq {v}_{0} ( {g}_{2} , {h}_{f} ) \leq {v}_{2} ( {g}_{2} , {h}_{f} ) \\ {v}_{1} ( {g}_{3} , {h}_{f} ) \leq {v}_{0} ( {g}_{3} , {h}_{f} ) \leq {v}_{2} ( {g}_{3} , {h}_{f} ) \\ {v}_{1} ( {g}_{4} , {h}_{f} ) \leq {v}_{0} ( {g}_{4} , {h}_{f} ) \leq {v}_{2} ( {g}_{4} , {h}_{f} )\end{matrix} \qquad ( 12 )$$

where v₀(g₀,h_{f}), v₀(g₁,h_{f}), v₀(g₂,h_{f}), v₀(g₃,h_{f}), v₀(g₄,h_{f}) represent travel speeds for vehicles on highways, first-grade roads, second-grade roads, third-grade roads, and fourth-grade roads, respectively; h_{f} represents a vehicle type; v₁(g₀,h_{f}), v₁(g₁,h_{f}), v₁(g₂,h_{f}), v₁(g₃,h_{f}), v₁(g₄,h_{f}) represent minimum design speeds for vehicles on highways, first-grade roads, second-grade roads, third-grade roads, and fourth-grade roads, respectively; v₂(g₀, h_{f}), v₂(g₁,h_{f}), v₂(g₂,h_{f}), v₂(g₃,h_{f}), v₂(g₄,h_{f}) represent maximum design speeds for vehicles on highways, first-grade roads, second-grade roads, third-grade roads, and fourth-grade roads, respectively.

Step 8.4: Establish constraints on traffic flow and property transfer volumes as follows:

$$\{ \begin{matrix}a ( {l}_{i , {k}_{f}} ) ∈ a ( {l}_{i , k} ) \\ {C}_{{q}_{f}} ( {h}_{f} ) = C ( {h}_{f} ) {\sum }_{{k}_{f} = 1}^{{x}^{f}} {x}_{i , {k}_{f}} a ( {l}_{i , {k}_{f}} ) \\ {b}_{i , f} = {C}_{{q}_{f}} ( {H}_{f} ) / {C}_{i} ( {H}_{f} ) \\ {b}_{i , f} \geq {b}_{i , f}^{min}\end{matrix} \qquad ( 13 )$$

where a(l_{i,k}) represents a set of traffic flow on all transfer routes for property risk zone i of the current village; a(l_{i,k}_{_{f}}) represents traffic flow on the k_{f}-th transfer route for type-H_{f} properties in property risk zone i of the current village; X_{i,k}_{_{f}} indicates whether to select the k_{f}-th feasible transfer route for property risk zone i of the current village, where the value is set to 1 if the k_{f}-th feasible transfer route is selected; otherwise, the value is set to 0; x^{f} represents the number of transfer routes for type-H_{f} properties in property risk zone i of the current village; C(h_{f}) represents a capacity of vehicle h_{f}; C_{q}_{_{f}}(H_{f}) represents a total amount of properties transferred from property risk zone i of the current village to placement site q_{f}; Cᵢ(H_{f}) represents an initial total amount of type-H_{f} properties awaiting transfer from property risk zone i of the current village; and b_{i,f} represents a transfer ratio of type-H_{f} properties; and

$${b}_{i , f}^{min}$$

represents a minimum transfer ratio for H_{f} corresponding to local standards.

Step 8.5: Solve the objective function (8) constructed in the present disclosure, namely, a shortest-time path model.

Based on the constraints from formulas (9), (12), and (13), the collected road network data is substituted into formula (10) to obtain time index values t_{c}(l_{i,k}) for each road segment and the corresponding traffic flow a(l_{i,k}) (the GIS has tools for recording traffic flow). t_{c}(l_{i,k}) is expressed as a matrix t(u,v). After iterations on the matrix t(u,v), a time route set t(l_{i,k}) and the corresponding traffic flow a(l_{i,k}) can be obtained. By comparing values of t(l_{i,k}), a shortest-time path set can be derived, which serves as the optimal flood evacuation route. The model solution steps are as follows:

By using village property risk zone i of the current village as a starting point, with n nodes c₁, c₂, . . . , cₙ in the intermediate road network, and placement sites in the village property safety zone being q₁, q₂, q₃, and q₄, a graph with n+5 vertexes is formed.

The directed graph is expressed as an adjacency directed matrix t, which is a (n+5)×(n+5) matrix. Thus, t(u,v) can represent a time index from node u to node v. If i→q₁, q₂, q₃, q₄ is taken as a positive direction, t(i,q₁) represents a time index between two nodes, while t(q₁,i) should be set to infinity to restrict the path-solving direction.

For initial calculation, the nodes are divided into two groups. Based on time indexes from the nodes to a source node, the nodes are classified into known shortest time index nodes and unknown time index nodes.

Using node i as the source node, node i and adjacent nodes in the direction of each property transfer route are placed into a known node set L1, and a set of time indexes from known nodes to the source node is stored as R. The remaining nodes form an unknown node set L2, and a set of time from unknown nodes to the source node is stored as r, with the time from the unknown nodes to the source node set to infinity.

Neighboring nodes in a solving direction of a termination node on a shortest path of the previous stage are sequentially placed into the set L1 until the endpoints q₁, q₂, q₃, and q₄ are placed in the set L1, leaving the unknown node set L2 empty. By comparing the sum t(l_{i,k}) of all time indexes in the time index set R for different routes as well as the corresponding traffic flow a(l_{i,k}), a series of shortest-time paths (with a minimum sum of time indexes) can be obtained, forming the optimal flood evacuation route. Meanwhile, the GIS can record the traffic flow a(l_{i,k}) corresponding to the shortest-time path, with the total of a(l_{i,k}) being the number of vehicles.

Step 9: Based on the optimal flood evacuation route, transfer the properties in the property risk zone of the current village to the placement site in the property safety zone of another village.

The method of the present disclosure calculates the impact of flood risk, determines property placement conditions, identifies risk zones, safety zones, and transfer routes, and dynamically computes an optimal property transfer route based on grid-based, classified, and dedicated-area property placement. Properties from each village property risk zone are transferred to a specified placement site in a property safety zone of another village based on the optimal flood evacuation route, achieving the safe and efficient property transfer and placement.

The following is a detailed description of the method of the present disclosure through a specific case, which also serves as a guide for applying the method of the present disclosure to property evacuation plans for flood emergencies in other regions. The specific case includes the following implementation steps:
S1: Collect basic geographic data, hydrometeorological data, and fundamental water facility data of a target area as basic data. The basic geographic data includes base terrain, road network, administrative division, digital elevation model, and remote sensing image data. The hydrometeorological data includes measured rainfall, streamflow, flow speed, and water level data from hydrological and meteorological stations within a watershed. The fundamental water facility data includes scales of flood control engineering facilities, engineering design parameters, and operational status data.
S2: Perform calculations based on the basic data of the target area by using a GIS combined with a two-dimensional hydrodynamic model, to generate a flood inundation map of the target area.
S3: Delineate village property risk zones and village property safety zones based on the flood inundation map of the target area.

For ease of presentation, this case simplifies the road network structure, retaining only important nodes, and reduces the number of village property risk zones and village property safety zones.

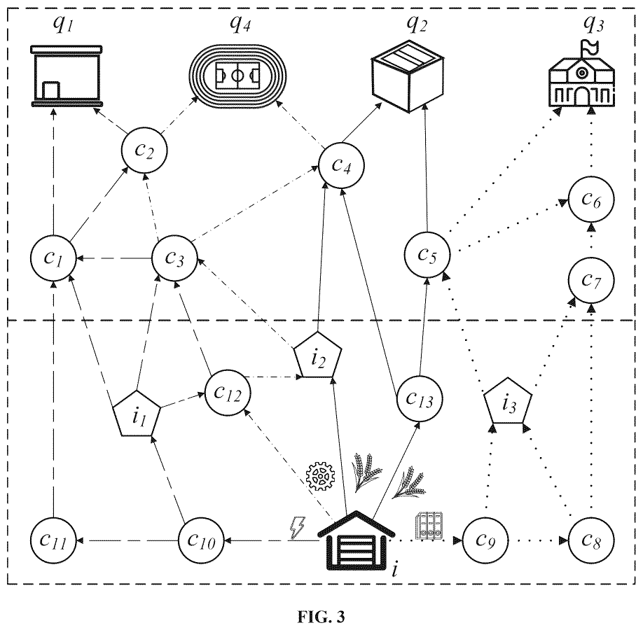

As shown in FIG. 3, using the GIS spatial analysis, i is identified as a risk zone of a current village, with i₁, i₂, and i₃ representing buildings, temporary storage facilities, and an area with a highest elevation (that is, high-elevation area), while q₁, q₂, q₃, and q₄ represent empty factories, warehouses, school classrooms, and school playgrounds in a property safety zone of another village, reflecting the mutual feedback relationships between “water” and “objects,” as well as “water” and “land.”
S4: Construct a road network topology based on the road network data of the target area, and performing road segment accessibility analysis based on the flood inundation map to form an accessible road network topology.
S5: Determine a property placement mode for a property risk zone of a current village based on the flood inundation map, where the property placement mode includes in-zone placement and transfer placement.
S6: If the property placement mode is in-zone placement, evacuating properties from the property risk zone of the current village to a placement site within the current village.
S7: If the property placement mode is transfer placement, by using the property risk zone of the current village as a starting point and a placement site in a property safety zone of another village as an endpoint, generate a feasible transfer placement route set based on rules of grid-based transfer, classified transport, and dedicated-area placement according to the accessible road network topology.

Rules of grid-based transfer, dedicated-area placement, and classified transport are established to generate a set containing all feasible transfer placement routes, reflecting the mutual feedback relationship between “objects” and “land.” As shown in FIG. 3, different line types correspond to the feasible transfer placement routes for different types of properties.

The present disclosure optimizes resource allocation, reduces resource waste, improves traffic efficiency, enhances transportation accuracy, and ensures the safety and efficiency of property transfers.
S8: Iteratively calculate paths for the feasible transfer placement route set based on a heuristic optimization algorithm, to determine an optimal flood evacuation route.

Since the vehicle transfer routes for various types of properties within the same village property risk zone do not overlap, the optimal path planning for electrical and mechanical equipment H₁ is taken as an example, and similar optimal path planning can be applied to H other types of properties.

By solving the shortest-time path model (10), the feasible shortest-time paths and the corresponding number of vehicles for the transfer routes can be obtained. Then, an optimal shortest-time path is determined in the following manner:

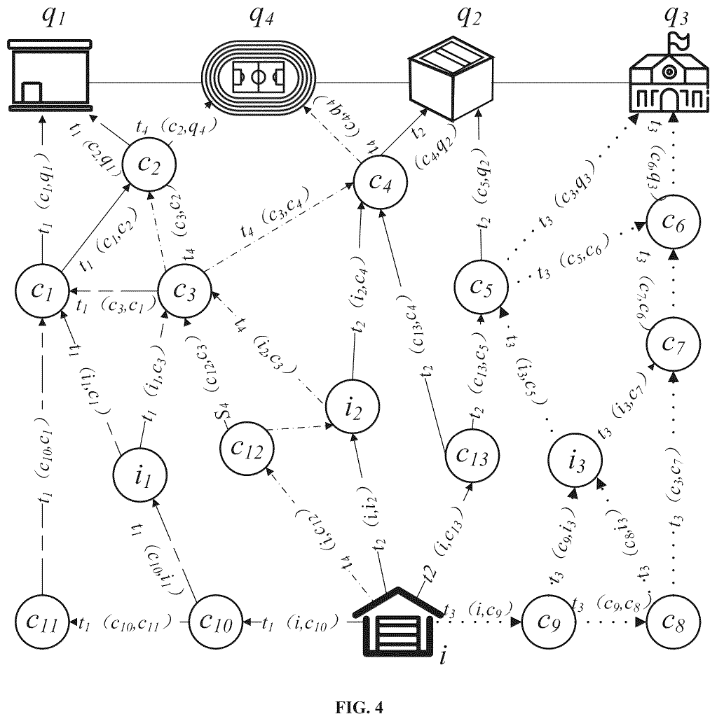

By using village property risk zone i of the current village as a starting point, with n nodes c₁, c₂, . . . , cₙ in the intermediate road network, and placement sites in the village property safety zone being q₁, q₂, q₃, and q₄, a graph with n+5 vertexes is formed, as shown in FIG. 4. The directed graph is expressed as an adjacency directed matrix t, which is a (n+5)×(n+5) matrix. Thus, t(u,v) can represent a time index from node u to node v. If i→q₁, q₂, q₃, q₄ is taken as a positive direction, t(i,q₁) represents a time index between two nodes, while t(q₁,i) should be set to infinity to restrict the path-solving direction.

TABLE 1
Directed matrix t for dynamic mutual feedback-
based property placement in flood evacuation

| t₁ (h) | i | c₁₀ | i₁ | c₃ | c₂ | c₁₁ | c₁ | q₁ |
|---|---|---|---|---|---|---|---|---|
| i | 0 | 1 | ∞ | ∞ | ∞ | ∞ | ∞ | ∞ |
| c₁₀ | ∞ | 0 | 1.5 | ∞ | ∞ | 1.3 | ∞ | ∞ |
| i₁ | ∞ | ∞ | 0 | 1.2 | ∞ | ∞ | 0.9 | ∞ |
| c₃ | ∞ | ∞ | ∞ | 0 | 0.7 | ∞ | 0.4 | ∞ |
| c₂ | ∞ | ∞ | ∞ | ∞ | 0 | ∞ | ∞ | 1.1 |
| c₁₁ | ∞ | ∞ | ∞ | ∞ | ∞ | 0 | 4 | ∞ |
| c₁ | ∞ | ∞ | ∞ | ∞ | 1.2 | ∞ | 0 | 3.1 |
| q₁ | ∞ | ∞ | ∞ | ∞ | ∞ | ∞ | ∞ | 0 |

The heuristic optimization algorithm is employed to iteratively solve for optimal paths, allowing adaptation to road network structures of varying scales and complexities. Through stage-by-stage optimization, rapid property placement during flood emergencies is achieved, enhancing the emergency response speed. Solving steps are as follows:

1. For initial calculation, the nodes are divided into two groups. Based on time from the nodes to a source node, the nodes are classified into known shortest-time path nodes and unknown path nodes.

For electrical and mechanical equipment H₁, node i is the source node. Node i and its H adjacent nodes c₁₀ are placed into a known node set L1, where L1={i,c₁₀} in this case, and a set of time from known nodes to the source node is stored as R₁={t(i,i), t(i,c₁₀)}. The remaining nodes form an unknown node set L2={i₁, c₁₁, c₁, c₂, c₃, q₁}, and a set of time from unknown nodes to the source node is stored as r={t(i,i₁),t(i,c₁₁),t(i,c₁),t(i,c₂),t(i,c₃),t(i,q₁)}. Initial conditions are as follows:

$${R}_{1} = \{ 0 , 1 \} \\ r = \{ x \vert x = ∞ \}$$

2. i₁ and c₁₁ are placed into the set L1, where L1={i,c₁₀,i₁,c₁₁} in this case, and sets of time from the known nodes to the source node are stored as R₁={t(i,i),t(i,c₁₀),t(c₁₀,i₁)} and R₂={t(i,i), t(i,c₁₀), t(c₁₀, c₁₁)}. The remaining nodes form L2={c₁,c₃,c₂,q₁}, and a set of time from the unknown nodes to the source nodes is stored as r={t(i,c₁),t(i,c₃),t(i,c₂),t(i,q₁)} A shortest time from the set L1 to the set L2 is determined:

$${R}_{1} = \{ 0 , 1 , 1.5 \} \\ {R}_{2} = \{ 0 , 1 , 1.3 \} \\ r = \{ x \vert x = ∞ \}$$

3. c₁ and c₃ are placed into the set L1, where L1={i, c₁₀, i₁, c₁₁,c₁, c₃} in this case, and sets of time from the known nodes to the source node are stored as R₁={t(i,i),t(i,c₁₀),t(c₁₀,i₁),t(i₁,c₃)}, R₂={t(i,i),t(i,c₁₀),t(c₁₀,c₁₁)}, and R₃={t(i,i),t(i,c₁₀),t(c₁₀,c₁₁),t(c₁₁,c₁)}. The remaining nodes form L2={c₂,q₁}, and a set of time from the unknown nodes to the source nodes is stored as r={t(i,c₂),t(i,q₁)}. A shortest time from the set L1 to the set L2 is determined:

$${R}_{1} = \{ 0 , 1 , 1.5 , 1.2 \} \\ {R}_{2} = \{ 0 , 1 , 1.5 , 0.9 \} \\ {R}_{3} = \{ 0 , 1 , 1.3 , 4 \} \\ r = \{ x \vert x = ∞ \}$$

4. c₂ is placed into the set L1, where L1={i,c₁₀,i₁, c₁₁,c₁,c₃,c₂} in this case, and sets of time from the known nodes to the source node are stored as

$${R}_{1} - \{ t ( i , i ) , t ( i , {c}_{10} ) , t ( {c}_{10} , {i}_{1} ) , t ( {i}_{1} , {c}_{3} ) , t ( {c}_{3} , {c}_{2} ) , t ( {c}_{2} , {q}_{1} ) \} , {R}_{2} = \{ t ( i , i ) , t ( i , {c}_{10} ) , t ( {c}_{10} , {i}_{1} ) , t ( {i}_{1} , {c}_{1} ) , t ( {c}_{1} , {c}_{2} ) , t ( {c}_{2} , {q}_{1} ) \} , {R}_{3} = \{ t ( i , i ) , t ( i , {c}_{10} ) , t ( {c}_{10} , {c}_{11} ) , t ( {c}_{11} , {c}_{1} ) , t ( {c}_{1} , {q}_{1} ) \} , {R}_{4} = \{ t ( i , i ) , t ( i , {c}_{10} ) , t ( {c}_{10} , {i}_{1} ) , t ( {i}_{1} , {c}_{3} ) , t ( {c}_{3} , {c}_{1} ) , t ( {c}_{1} , {c}_{2} ) , t ( {c}_{2} , {q}_{1} ) \} .$$

The remaining nodes form L2={q₁}, and a set of time from the unknown nodes to the source nodes is stored as r={t(i,q₁)} A shortest time from the set L1 to the set L2 is determined:

$${R}_{1} = \{ 0 , 1 , 1.5 , 1.2 , 1.1 \} \\ {R}_{2} = \{ 0 , 1 , 1.5 , 0.9 , 1.1 \} \\ {R}_{3} = \{ 0 , 1 , 1.3 , 4 , 3.1 \} \\ {R}_{4} = \{ 0 , 1 , 1.3 , 0.9 , 3.1 \} \\ r = \{ x \vert x = ∞ \}$$

5. q₁ is placed into the set L1, where L1={i,c₁₀,i₁,c₁₁,c₁,c₃,c₂,q₁} in this case, while L2=ϕ. Node storage is stopped, and route calculations are performed, with transfer routes and their time values as follows:

$$i \to {c}_{10} \to {i}_{1} \to {c}_{3} \to {c}_{2} \to {q}_{1} : 4.8 h ;$$

$$i \to {c}_{10} \to {i}_{1} \to {c}_{1} \to {c}_{2} \to {q}_{1} : 4.5 h ;$$

$$i \to {c}_{10} \to {c}_{11} \to {c}_{1} \to {q}_{1} : 9.4 h ;$$

$$i \to {c}_{10} \to {i}_{1} \to {c}_{3} \to {c}_{1} \to {c}_{2} \to {q}_{1} : 6.3 h .$$

Based on the above, transfer routes for all properties within the risk zone can be obtained. A shortest path for transfer placement of electrical and mechanical equipment H₁ is i→c₁₀→i₁→c₁→c²→q₁ (4.5 hours), which is the optimal flood evacuation route. Using the GIS, the corresponding number of vehicles a(l_{i,k}_{_{f}}) for each route can be recorded.

S9: Based on the optimal flood evacuation route i→c₁₀→i₁→c₁→c₂→q₁, transfer electrical and mechanical equipment H₁ in the property risk zone of the current H village to the placement site in the property safety zone of another village.

In some embodiments, the present disclosure further provides a computer program product, including a computer program. The computer program, when executed by a processor, implements the dynamic mutual feedback-based method for property placement in flood evacuation.

In some embodiments, the present disclosure further provides a computer-readable storage medium storing a computer program, where the computer program, when executed by a processor, implements the dynamic mutual feedback-based method for property placement in flood evacuation.

In some embodiments, the present disclosure further provides a computer device. The computer device includes a processor, a memory, an input/output (I/O) interface and a communication interface. The processor, the memory and the I/O interface are connected through a system bus. The communication interface is connected to the system bus through the I/O interface. The processor of the computer apparatus is configured to provide computing and control capabilities. The memory of the computer device includes a non-volatile storage medium and an internal memory. The non-volatile storage medium stores an operating system, a computer program, and a database. The internal memory provides an environment for operation of the operating system and the computer program in the non-volatile storage medium. The database of the computer device is configured to store pending transactions. The I/O interface of the computer device is configured to exchange information between the processor and an external device. The communication interface of the computer device is configured to communicate with an external terminal through a network. The computer program, when executed by a processor, can implement the dynamic mutual feedback-based method for property placement in flood evacuation.

In step 3 of the method provided by the present disclosure, an area composed of risk grid cells is identified as a village property risk zone, and an area composed of safe grid cells is identified as a village property safety zone; village property risk zones and village property safety zones are defined with administrative boundaries as the framework, thereby providing foundational support for the orderly development of subsequent property placement tasks.

In step 5, a GIS spatial analysis is conducted to determine the placement modes for different types of properties in the village property risk zone and the corresponding placement sites based on flood risk conditions of the village property risk zone. This reflects the mutual feedback relationships between “water” and “objects,” as well as “water” and “land.”

In step 7, the rules of grid-based transfer, dedicated-area placement, and classified transport are established to generate a set of all feasible transfer placement routes, reflecting the mutual feedback relationship between “objects” and “land.” Through these methods, the present disclosure optimizes resource allocation, reduces resource waste, improves traffic efficiency, and enhances the accuracy of transportation, thereby ensuring the safety and efficiency of property transfers.

In step 8, the shortest-time path model is constructed, which enhances the adaptation to flood events and improves the quality of flood evacuation decisions. The heuristic optimization algorithm is employed to iteratively solve for optimal paths, allowing adaptation to road network structures of varying scales and complexities. Through stage-by-stage optimization, rapid property placement during flood emergencies is achieved, enhancing the emergency response speed.

Particular examples are used herein for illustration of principles and implementation modes of the present disclosure. The descriptions of the above embodiments are merely used for assisting in understanding the method of the present disclosure and its core ideas. In addition, those of ordinary skill in the art can make various modifications in terms of particular implementation modes and the scope of application in accordance with the ideas of the present disclosure. In conclusion, the content of the description shall not be construed as limitations to the present disclosure.

What is claimed is:

1. A dynamic mutual feedback-based method for property placement in flood evacuation, comprising:
collecting basic geographic data, hydrometeorological data, and fundamental water facility data of a target area as basic data, wherein the basic geographic data comprises base terrain, road network, administrative division, digital elevation model, and remote sensing image data; the hydrometeorological data comprises measured rainfall, streamflow, flow speed, and water level data from hydrological and meteorological stations within a watershed; and the fundamental water facility data comprises scales of flood control engineering facilities, engineering design parameters, and operational status data;
performing calculations based on the basic data of the target area by using a Geographic Information System (GIS) combined with a two-dimensional hydrodynamic model, to generate a flood inundation map of the target area;
delineating village property risk zones and village property safety zones based on the flood inundation map of the target area;
constructing a road network topology based on the road network data of the target area, and performing road segment accessibility analysis based on the flood inundation map to form an accessible road network topology;
determining a property placement mode for a property risk zone of a current village based on the flood inundation map, wherein the property placement mode comprises in-zone placement and transfer placement;
if the property placement mode is in-zone placement, evacuating properties from the property risk zone of the current village to a placement site within the current village;
if the property placement mode is transfer placement, by using the property risk zone of the current village as a starting point and a placement site in a property safety zone of another village as an endpoint, generating a feasible transfer placement route set based on rules of grid-based transfer, classified transport, and dedicated-area placement according to the accessible road network topology;
iteratively calculating paths for the feasible transfer placement route set based on a heuristic optimization algorithm to determine an optimal flood evacuation route; and
based on the optimal flood evacuation route, transferring the properties in the property risk zone of the current village to the placement site in the property safety zone of another village.

2. The dynamic mutual feedback-based method for property placement in flood evacuation according to claim 1, wherein said performing calculations based on the basic data of the target area by using the GIS combined with the two-dimensional hydrodynamic model, to generate the flood inundation map of the target area comprises:
dividing the target area into grid cells using two-dimensional hydrodynamic modeling software;
setting boundary conditions, initial conditions, and input parameters for the two-dimensional hydrodynamic model based on the basic data of the target area, and performing calculations using the two-dimensional hydrodynamic modeling software to obtain risk factor values for each grid cell, wherein risk factors for each grid cell comprise: flood peak arrival time, inundation depth, and inundation duration; and
converting the risk factor values of each grid cell into visual graphics using the GIS, to obtain the flood inundation map of the target area.

3. The dynamic mutual feedback-based method for property placement in flood evacuation according to claim 2, wherein said delineating the village property risk zones and the village property safety zones based on the flood inundation map of the target area comprises:
defining the village property risk zones according to the following formula:
$$M = {\sum }_{m = 1}^{x} {S}_{m , j} ( Z > {Z}_{0} ) , {S}_{m , j} ∈ {S}_{j} ,$$
wherein M represents a range of a village property risk zone; Sⱼ represents an administrative region of village j; S_{m,j} represents an m-th grid area of village j; Z represents an inundation depth of a grid cell; Z₀ represents an actual elevation of a grid cell; S_{m,j}(Z>Z₀) represents a risk grid area; and x represents the number of risk grid cells; and
defining the village property safety zones according to the following formula:
$$D = {\sum }_{d = 1}^{y} {S}_{d , j} ( Z \leq {Z}_{0} ) , {S}_{d , j} ∈ {S}_{j} ,$$
wherein D represents a range of a village property safety zone; S_{d,j} represents a d-th grid area of village j; S_{d,j}(Z≤Z₀) represents a safety grid area; and y represents the number of safety grid cells.

4. The dynamic mutual feedback-based method for property placement in flood evacuation according to claim 3, wherein said constructing the road network topology based on the road network data of the target area, and performing road segment accessibility analysis based on the flood inundation map to form the accessible road network topology comprises:
with road data from the road network data as edges, creating nodes at road intersections and endpoints, and assigning attributes to the edges and the nodes within a road network, to form an initial road network topology;
determining flooded road segments in the initial road network topology and corresponding inundation depths based on the flood inundation map;
treating road segments with the inundation depths exceeding a preset distance from road surface as impassable road segments; and
severing the impassable road segments in the initial road network topology by using a node tool in the GIS, to form the accessible road network topology.

5. The dynamic mutual feedback-based method for property placement in flood evacuation according to claim 4, wherein said determining the property placement mode for the property risk zone of the current village based on the flood inundation map comprises:
when identification conditions
$$\{ \begin{matrix}{Z}_{{i}_{p}} > {Z}_{i} + {Z}_{i}^{′} \\ {\sum }_{i = 1}^{{x}_{1}} {C}_{i , {H}_{f}} \leq {\sum }_{{i}_{p} = 1}^{{z}_{1}} {C}_{{i}_{p} , {H}_{f}}^{max} \\ {i}_{p} ∈ \{ {i}_{1} , {i}_{2} , {i}_{3} \} \\ {H}_{f} ∈ \{ {H}_{1} , {H}_{2} , {H}_{3} \}\end{matrix}$$
for the placement site in the property risk zone of the current village are satisfied, determining that the property placement mode for the property risk zone of the current village is in-zone placement, wherein C_{i,H}_{_{f}} represents the number of type-H_{f} properties in property risk zone i of the current village; X₁ represents the number of property risk zones in the current village; iₚ represents a placement site in property risk zone i of the current village, referred to as a placement site in the current village; i₁ represents buildings in the current village; i₂ represents temporary storage facilities in the current village; i₃ represents a high-elevation area in the current village; [symbol] represents the number of placement sites in the current village; H_{f} represents a property type; H₁ represents electrical and mechanical equipment; H₂ represents grains and oils; H₃ represents important archival documents;
$${C}_{{i}_{p} , {H}_{f}}^{max}$$
represents a maximum capacity for type-H_{f} properties in placement site iₚ of the current village; Zᵢ_{ₚ} represents a height of placement site iₚ in the current village; Zᵢ represents an inundation depth of property risk zone i in the current village; and Z′ᵢ represents a safety margin of property risk zone i in the current village; and
when identification conditions
$$\{ \begin{matrix}{Z}_{{i}_{p}} \leq {Z}_{i} + {Z}_{i}^{′} \\ {\sum }_{i = 1}^{{x}_{1}} {C}_{i , {H}_{f}} \leq {\sum }_{{q}_{p} = 1}^{{z}_{2}} {C}_{{q}_{p} , {H}_{f}}^{max} \\ {q}_{p} ∈ \{ {q}_{1} , {q}_{2} , {q}_{3} , {q}_{4} \}\end{matrix}$$
for a placement site in a property safety zone of another village are satisfied, determining that the property placement mode for the property risk zone of the current village is transfer placement, wherein qₚ represents a placement site in a property safety zone of another village, referred to as a placement site in another village; q₁ represents empty factories; q₂ represents warehouses; q₃ represents school classrooms; q₄ represents school playgrounds; [symbol] represents the number of placement sites in another village; and
$${C}_{{q}_{p} , {H}_{f}}^{max}$$
represents a maximum capacity for type-H_{f} properties in placement site qₚ of another village.

6. The dynamic mutual feedback-based method for property placement in flood evacuation according to claim 5, wherein said generating the feasible transfer placement route set based on the rules of grid-based transfer, classified transport, and dedicated-area placement according to the accessible road network topology comprises:
establishing a grid-based transfer rule in which transfer routes of property risk zones of different villages do not overlap:
$$\{ \begin{matrix}H ( i ) = H ( q ) + H ( {i}^{0} ) \\ ∀ i , {i}^{′} ∈ \{ 1 , 2 , … , {x}_{1} \} , i \neq {i}^{′} ⟹ ( {l}_{i} ⋂ {l}_{{i}^{′}} = ∅ )\end{matrix} ,$$
wherein lᵢ represents all feasible transfer routes related to property risk zone i of the current village in the accessible road network topology; l_{i′} represents all feasible transfer routes related to property risk zone i′ in the accessible road network topology; H(i) represents a collection of properties awaiting transfer from property risk zone i of the current village; H(q) represents a collection of properties being transferred from property risk zone i of the current village to placement site qₚ in another village; and H(i⁰) represents a collection of properties placed in placement site iₚ in the current village;
establishing a classified transport rule that prevents vehicle routes for transferring different types of properties from competing for space:
$$\{ \begin{matrix}∀ i , {i}^{′} ∈ \{ 1 , 2 , … , {x}_{1} \} , i \neq {i}^{′} ⟹ ( {L}_{i} ⋂ {L}_{{i}^{′}} = ∅ ) \\ for {h}_{f} ∈ \{ {h}_{1} , {h}_{2} , {h}_{3} , {h}_{4} \}\end{matrix} ,$$
wherein h_{f} represents vehicles for transporting different types of properties; h₁ represents trucks for transporting electrical and mechanical equipment; h₂ represents trucks for transporting grains and oils; h₃ represents pickup trucks for transporting important archival documents; h₄ represents trucks for transporting other important properties of residents; Lᵢ represents feasible transfer routes for all property transfer vehicles in property risk zone i of the current village in the accessible road network topology; and Lᵢ represents feasible transfer routes for all property transfer vehicles in property risk zone i′ of the current village in the accessible road network topology;
establishing a dedicated-area placement rule that stores different types of properties at corresponding placement sites:
$$\{ \begin{matrix}{H}_{f} ( {q}_{f} ) ∈ {H}_{f} ( i ) \\ {H}_{f} = \{ {H}_{1} , {H}_{2} , {H}_{3} , {H}_{4} \} \\ {q}_{f} ∈ {q}_{p}\end{matrix} ,$$
wherein q_{f} represents dedicated areas for storing different types of properties at placement site qₚ of another village; H₄ represents other important properties of residents; H_{f}(i) represents types of properties awaiting transfer from property risk zone i of the current village; and H_{f}(q_{f}) represents types of properties being transferred from property risk zone i of the current village to dedicated areas q_{f}; and
for property risk zone i of the current village of which the property placement mode is transfer placement, by using a GIS spatial analysis, generating the feasible transfer placement route set containing all feasible transfer placement routes based on the rules of grid-based transfer, classified transport, and dedicated-area placement, with property risk zone i of the current village as a starting point and placement site qₚ in another village as an endpoint.

7. The dynamic mutual feedback-based method for property placement in flood evacuation according to claim 6, wherein said iteratively calculating paths for the feasible transfer placement route set based on the heuristic optimization algorithm to determine the optimal flood evacuation route comprises:
constructing an objective function
$$f = min T = min {\sum }_{i = 1}^{{x}_{1}} {\sum }_{k = 1}^{{x}_{2}} a ( {l}_{i , k} ) \times t ( {l}_{i , k} )$$
for the optimal flood evacuation route as well as corresponding constraints, wherein the constraints comprises constraints on road segment travel time, constraints on road design speeds, and constraints on traffic flow and property transfer volumes, wherein T represents a total transfer time; l_{i,k} represents the k-th feasible transfer placement route for property risk zone i of the current village; a(l_{i,k}) and t(l_{i,k}) represent a traffic flow and time consumed for property transfer via feasible transfer placement route l_{i,k}, respectively; and X₂ represents the number of feasible transfer placement routes for property risk zone i of the current village; and
iteratively calculating paths for the feasible transfer placement route set based on the heuristic optimization algorithm, to determine an optimal flood evacuation route that satisfies the objective function and the corresponding constraints.

8. A non-transitory computer-readable storage medium, wherein the computer-readable storage medium stores a computer program, and the computer program, when executed by a processor, implements the dynamic mutual feedback-based method for property placement in flood evacuation according to claim 1.

9. A computer device, comprising a memory, a processor, and a computer program stored in the memory and executable on the processor, wherein the computer program, when executed by the processor, implements the dynamic mutual feedback-based method for property placement in flood evacuation according to claim 1.

10. The non-transitory computer-readable storage medium according to claim 8, wherein said performing calculations based on the basic data of the target area by using the GIS combined with the two-dimensional hydrodynamic model, to generate the flood inundation map of the target area comprises:
dividing the target area into grid cells using two-dimensional hydrodynamic modeling software;
setting boundary conditions, initial conditions, and input parameters for the two-dimensional hydrodynamic model based on the basic data of the target area, and performing calculations using the two-dimensional hydrodynamic modeling software to obtain risk factor values for each grid cell, wherein risk factors for each grid cell comprise: flood peak arrival time, inundation depth, and inundation duration; and
converting the risk factor values of each grid cell into visual graphics using the GIS, to obtain the flood inundation map of the target area.

11. The non-transitory computer-readable storage medium according to claim 10, wherein said delineating the village property risk zones and the village property safety zones based on the flood inundation map of the target area comprises:
defining the village property risk zones according to the following formula:
$$M = {\sum }_{m = 1}^{x} {S}_{m , j} ( Z > {Z}_{0} ) , {S}_{m , j} ∈ {S}_{j} ,$$
wherein M represents a range of a village property risk zone; Sⱼ represents an administrative region of village j; S_{m,j} represents an m-th grid area of village j; Z represents an inundation depth of a grid cell; Z₀ represents an actual elevation of a grid cell; S_{m,j}(Z>Z₀) represents a risk grid area; and x represents the number of risk grid cells; and
defining the village property safety zones according to the following formula:
$$D = {\sum }_{d = 1}^{y} {S}_{d , j} ( Z \leq {Z}_{0} ) , {S}_{d , j} ∈ {S}_{j} ,$$
wherein D represents a range of a village property safety zone; S_{d,j} represents a d-th grid area of village j; S_{d,j}(Z≤Z₀) represents a safety grid area; and y represents the number of safety grid cells.

12. The non-transitory computer-readable storage medium according to claim 11, wherein said constructing the road network topology based on the road network data of the target area, and performing road segment accessibility analysis based on the flood inundation map to form the accessible road network topology comprises:
with road data from the road network data as edges, creating nodes at road intersections and endpoints, and assigning attributes to the edges and the nodes within a road network, to form an initial road network topology;
determining flooded road segments in the initial road network topology and corresponding inundation depths based on the flood inundation map;
treating road segments with the inundation depths exceeding a preset distance from road surface as impassable road segments; and
severing the impassable road segments in the initial road network topology by using a node tool in the GIS, to form the accessible road network topology.

13. The non-transitory computer-readable storage medium according to claim 12, wherein said determining the property placement mode for the property risk zone of the current village based on the flood inundation map comprises:
when identification conditions
$$\{ \begin{matrix}{Z}_{{i}_{p}} > {Z}_{i} + {Z}_{i}^{′} \\ {\sum }_{i = 1}^{{x}_{1}} {C}_{i , {H}_{f}} \leq {\sum }_{{i}_{p} = 1}^{{z}_{1}} {C}_{{i}_{p} , {H}_{f}}^{max} \\ {i}_{p} ∈ \{ {i}_{1} , {i}_{2} , {i}_{3} \} \\ {H}_{f} ∈ \{ {H}_{1} , {H}_{2} , {H}_{3} \}\end{matrix}$$
for the placement site in the property risk zone of the current village are satisfied, determining that the property placement mode for the property risk zone of the current village is in-zone placement, wherein C_{i,H}_{_{f}} represents the number of type-H_{f} properties in property risk zone i of the current village; X₁ represents the number of property risk zones in the current village; iₚ represents a placement site in property risk zone i of the current village, referred to as a placement site in the current village; i₁ represents buildings in the current village; i₂ represents temporary storage facilities in the current village; i₃ represents a high-elevation area in the current village; [symbol] represents the number of placement sites in the current village; H_{f} represents a property type; H₁ represents electrical and mechanical equipment; H₂ represents grains and oils; H₃ represents important archival documents;
$${C}_{{i}_{p} , {H}_{f}}^{max}$$
represents a maximum capacity for type-H_{f} properties in placement site iₚ of the current village; Zᵢ_{ₚ} represents a height of placement site iₚ in the current village; Zᵢ represents an inundation depth of property risk zone i in the current village; and Z′ᵢ represents a safety margin of property risk zone i in the current village; and
when identification conditions
$$\{ \begin{matrix}{Z}_{{i}_{p}} \leq {Z}_{i} + {Z}_{i}^{′} \\ {\sum }_{i = 1}^{{x}_{1}} {C}_{i , {H}_{f}} \leq {\sum }_{{q}_{p} = 1}^{{z}_{2}} {C}_{{q}_{p} , {H}_{f}}^{max} \\ {q}_{p} ∈ \{ {q}_{1} , {q}_{2} , {q}_{3} , {q}_{4} \}\end{matrix}$$
for a placement site in a property safety zone of another village are satisfied, determining that the property placement mode for the property risk zone of the current village is transfer placement, wherein qₚ represents a placement site in a property safety zone of another village, referred to as a placement site in another village; q₁ represents empty factories; q₂ represents warehouses; q₃ represents school classrooms; q₄ represents school playgrounds; [symbol] represents the number of placement sites in another village; and
$${C}_{{q}_{p} , {H}_{f}}^{max}$$
represents a maximum capacity for type-H_{f} properties in placement site qₚ of another village.

14. The non-transitory computer-readable storage medium according to claim 13, wherein said generating the feasible transfer placement route set based on the rules of grid-based transfer, classified transport, and dedicated-area placement according to the accessible road network topology comprises:
establishing a grid-based transfer rule in which transfer routes of property risk zones of different villages do not overlap:
$$\{ \begin{matrix}H ( i ) = H ( q ) + H ( {i}^{0} ) \\ ∀ i , {i}^{′} ∈ \{ 1 , 2 , … , {x}_{1} \} , i \neq {i}^{′} ⟹ ( {l}_{i} ∩ {l}_{{i}^{′}} = ⌀ )\end{matrix} ,$$
wherein lᵢ represents all feasible transfer routes related to property risk zone i of the current village in the accessible road network topology; l_{i′} represents all feasible transfer routes related to property risk zone i′ in the accessible road network topology; H(i) represents a collection of properties awaiting transfer from property risk zone i of the current village; H(q) represents a awaiting transfer from property risk zone collection of properties being transferred from property risk zone i of the current village to placement site qₚ in another village; and H(i⁰) represents a collection of properties placed in placement site iₚ in the current village;
establishing a classified transport rule that prevents vehicle routes for transferring different types of properties from competing for space:
$$\{ \begin{matrix}∀ i , {i}^{′} ∈ \{ 1 , 2 , … , {x}_{1} \} , i \neq {i}^{′} ⟹ ( {L}_{i} ∩ {L}_{{i}^{′}} = ⌀ ) \\ for {h}_{f} ∈ \{ {h}_{1} , {h}_{2} , {h}_{3} , {h}_{4} \}\end{matrix} ,$$
wherein h_{f} represents vehicles for transporting different types of properties; h₁ represents trucks for transporting electrical and mechanical equipment; h₂ represents trucks for transporting grains and oils; h₃ represents pickup trucks for transporting important archival documents; h₄ represents trucks for transporting other important properties of residents; Lᵢ represents feasible transfer routes for all property transfer vehicles in property risk zone i of the current village in the accessible road network topology; and L_{i′} represents feasible transfer routes for all property transfer vehicles in property risk zone i′ of the current village in the accessible road network topology;
establishing a dedicated-area placement rule that stores different types of properties at corresponding placement sites:
$$\{ \begin{matrix}{H}_{f} ( {q}_{f} ) ∈ {H}_{f} ( i ) \\ {H}_{f} = \{ {H}_{1} , {H}_{2} , {H}_{3} , {H}_{4} \} \\ {q}_{f} ∈ {q}_{p}\end{matrix} ,$$
wherein q_{f} represents dedicated areas for storing different types of properties at placement site qₚ of another village; H₄ represents other important properties of residents; H_{f}(i) represents types of properties awaiting transfer from property risk zone i of the current village; and H_{f}(q_{f}) represents types of properties being transferred from property risk zone i of the current village to dedicated areas q_{f}; and
for property risk zone i of the current village of which the property placement mode is transfer placement, by using a GIS spatial analysis, generating the feasible transfer placement route set containing all feasible transfer placement routes based on the rules of grid-based transfer, classified transport, and dedicated-area placement, with property risk zone i of the current village as a starting point and placement site qₚ in another village as an endpoint.

15. The non-transitory computer-readable storage medium according to claim 14, wherein said iteratively calculating paths for the feasible transfer placement route set based on the heuristic optimization algorithm to determine the optimal flood evacuation route comprises:
constructing an objective function
$$f = min T = min {\sum }_{i = 1}^{{x}_{1}} {\sum }_{k = 1}^{{x}_{2}} a ( {l}_{i , k} ) \times t ( {l}_{i , k} )$$
for the optimal flood evacuation route as well as corresponding constraints, wherein the constraints comprises constraints on road segment travel time, constraints on road design speeds, and constraints on traffic flow and property transfer volumes, wherein T represents a total transfer time; l_{i,k} represents the k-th feasible transfer placement route for property risk zone i of the current village; a(l_{i,k}) and t(l_{i,k}) represent a traffic flow and time consumed for property transfer via feasible transfer placement route l_{i,k}, respectively; and X₂ represents the number of feasible transfer placement routes for property risk zone i of the current village; and
iteratively calculating paths for the feasible transfer placement route set based on the heuristic optimization algorithm, to determine an optimal flood evacuation route that satisfies the objective function and the corresponding constraints.

16. The computer device according to claim 9, wherein said performing calculations based on the basic data of the target area by using the GIS combined with the two-dimensional hydrodynamic model, to generate the flood inundation map of the target area comprises:
dividing the target area into grid cells using two-dimensional hydrodynamic modeling software;
setting boundary conditions, initial conditions, and input parameters for the two-dimensional hydrodynamic model based on the basic data of the target area, and performing calculations using the two-dimensional hydrodynamic modeling software to obtain risk factor values for each grid cell, wherein risk factors for each grid cell comprise: flood peak arrival time, inundation depth, and inundation duration; and
converting the risk factor values of each grid cell into visual graphics using the GIS, to obtain the flood inundation map of the target area.

17. The computer device according to claim 16, wherein said delineating the village property risk zones and the village property safety zones based on the flood inundation map of the target area comprises:
defining the village property risk zones according to the following formula:
$$M = {\sum }_{m = 1}^{x} {S}_{m , j} ( Z > {Z}_{0} ) , {S}_{m , j} ∈ {S}_{j} ,$$
wherein M represents a range of a village property risk zone; Sⱼ represents an administrative region of village j; S_{m,j} represents an m-th grid area of village j; Z represents an inundation depth of a grid cell; Z₀ represents an actual elevation of a grid cell; S_{m,j}(Z>Z₀) represents a risk grid area; and x represents the number of risk grid cells; and
defining the village property safety zones according to the following formula:
$$D = {\sum }_{d = 1}^{y} {S}_{d , j} ( Z \leq {Z}_{0} ) , {S}_{d , j} ∈ {S}_{j} ,$$
wherein D represents a range of a village property safety zone; S_{d,j} represents a d-th grid area of village j; S_{d,j}(Z≤Z₀) represents a safety grid area; and y represents the number of safety grid cells.

18. The computer device according to claim 17, wherein said constructing the road network topology based on the road network data of the target area, and performing road segment accessibility analysis based on the flood inundation map to form the accessible road network topology comprises:
with road data from the road network data as edges, creating nodes at road intersections and endpoints, and assigning attributes to the edges and the nodes within a road network, to form an initial road network topology;
determining flooded road segments in the initial road network topology and corresponding inundation depths based on the flood inundation map;
treating road segments with the inundation depths exceeding a preset distance from road surface as impassable road segments; and
severing the impassable road segments in the initial road network topology by using a node tool in the GIS, to form the accessible road network topology.

19. The computer device according to claim 18, wherein said determining the property placement mode for the property risk zone of the current village based on the flood inundation map comprises:
when identification conditions
$$\{ \begin{matrix}{Z}_{{i}_{p}} > {Z}_{i} + {Z}_{i}^{′} \\ {\sum }_{i = 1}^{{x}_{1}} {C}_{i , {H}_{f}} \leq {\sum }_{{i}_{p} = 1}^{{z}_{1}} {C}_{{i}_{p} , {H}_{f}}^{max} \\ {i}_{p} ∈ \{ {i}_{1} , {i}_{2} , {i}_{3} \} \\ {H}_{f} ∈ \{ {H}_{1} , {H}_{2} , {H}_{3} \}\end{matrix}$$
for the placement site in the property risk zone of the current village are satisfied, determining that the property placement mode for the property risk zone of the current village is in-zone placement, wherein C_{i,H}_{_{f}} represents the number of type-H_{f} properties in property risk zone i of the current village; X₁ represents the number of property risk zones in the current village; iₚ represents a placement site in property risk zone i of the current village, referred to as a placement site in the current village; i₁ represents buildings in the current village; i₂ represents temporary storage facilities in the current village; i₃ represents a high-elevation area in the current village; [symbol] represents the number of placement sites in the current village; H_{f} represents a property type; H₁ represents electrical and mechanical equipment; H₂ represents grains and oils; H₃ represents important archival documents;
$${C}_{{i}_{p} , {H}_{f}}^{max}$$
represents a maximum capacity for type-H_{f} properties in placement site iₚ of the current village; Zᵢ_{ₚ} represents a height of placement site iₚ in the current village; Zᵢ represents an inundation depth of property risk zone i in the current village; and Z′ᵢ represents a safety margin of property risk zone i in the current village; and
when identification conditions
$$\{ \begin{matrix}{Z}_{{i}_{p}} \leq {Z}_{i} + {Z}_{i}^{′} \\ {\sum }_{i = 1}^{{x}_{1}} {C}_{i , {H}_{f}} \leq {\sum }_{{q}_{p} = 1}^{{z}_{2}} {C}_{{q}_{p} , {H}_{f}}^{max} \\ {q}_{p} ∈ \{ {q}_{1} , {q}_{2} , {q}_{3} , {q}_{4} \}\end{matrix}$$
for a placement site in a property safety zone of another village are satisfied, determining that the property placement mode for the property risk zone of the current village is transfer placement, wherein qₚ represents a placement site in a property safety zone of another village, referred to as a placement site in another village; q₁ represents empty factories; q₂ represents warehouses; q₃ represents school classrooms; q₄ represents school playgrounds; [symbol] represents the number of placement sites in another village; and
$${C}_{{q}_{p} , {H}_{f}}^{max}$$
represents a maximum capacity for type-H_{f} properties in placement site qₚ of another village.

20. The computer device according to claim 19, wherein said generating the feasible transfer placement route set based on the rules of grid-based transfer, classified transport, and dedicated-area placement according to the accessible road network topology comprises:
establishing a grid-based transfer rule in which transfer routes of property risk zones of different villages do not overlap:
$$\{ \begin{matrix}H ( i ) = H ( q ) + H ( {i}^{0} ) \\ ∀ i , {i}^{′} ∈ \{ 1 , 2 , … , {x}_{1} \} , i \neq {i}^{′} ⟹ ( {l}_{i} ∩ {l}_{{i}^{′}} = ⌀ )\end{matrix} ,$$
wherein lᵢ represents all feasible transfer routes related to property risk zone i of the current village in the accessible road network topology; l_{i′} represents all feasible transfer routes related to property risk zone i′ in the accessible road network topology; H(i) represents a collection of properties awaiting transfer from property risk zone i of the current village; H(q) represents a collection of properties being transferred from property risk zone i of the current village to placement site qₚ in another village; and H(i⁰) represents a collection of properties placed in placement site iₚ in the current village;
establishing a classified transport rule that prevents vehicle routes for transferring different types of properties from competing for space:
$$\{ \begin{matrix}∀ i , {i}^{′} ∈ \{ 1 , 2 , … , {x}_{1} \} , i \neq {i}^{′} ⟹ ( {L}_{i} ∩ {L}_{{i}^{′}} = ⌀ ) \\ for {h}_{f} ∈ \{ {h}_{1} , {h}_{2} , {h}_{3} , {h}_{4} \}\end{matrix} ,$$
wherein h_{f} represents vehicles for transporting different types of properties; h₁ represents trucks for transporting electrical and mechanical equipment; h₂ represents trucks for transporting grains and oils; h₃ represents pickup trucks for transporting important archival documents; h₄ represents trucks for transporting other important properties of residents; Lᵢ represents feasible transfer routes for all property transfer vehicles in property risk zone i of the current village in the accessible road network topology; and L_{i′} represents feasible transfer routes for all property transfer vehicles in property risk zone i′ of the current village in the accessible road network topology;
establishing a dedicated-area placement rule that stores different types of properties at corresponding placement sites:
$$\{ \begin{matrix}{H}_{f} ( {q}_{f} ) ∈ {H}_{f} ( i ) \\ {H}_{f} = \{ {H}_{1} , {H}_{2} , {H}_{3} , {H}_{4} \} \\ {q}_{f} ∈ {q}_{p}\end{matrix} ,$$
wherein q_{f} represents dedicated areas for storing different types of properties at placement site qₚ of another village; H₄ represents other important properties of residents; H_{f}(i) represents types of properties awaiting transfer from property risk zone i of the current village; and H_{f}(q_{f}) represents types of properties being transferred from property risk zone i of the current village to dedicated areas q_{f}; and
for property risk zone i of the current village of which the property placement mode is transfer placement, by using a GIS spatial analysis, generating the feasible transfer placement route set containing all feasible transfer placement routes based on the rules of grid-based transfer, classified transport, and dedicated-area placement, with property risk zone i of the current village as a starting point and placement site qₚ in another village as an endpoint.
